(19) United States
(12) Patent Application Publication
(10) Pub. No.: US 2011/0168029 A1
(43) Pub. Date: Jul. 14, 2011

(54) COFFEE POD ADAPTER

(76) Inventor: Vincenzo Fulco, Prospect Park, NJ (US)

(21) Appl. No.: 13/017,663

(22) Filed: Jan. 31, 2011

(51) Int. Cl. A47J 31/44; B23P 19/04

(52) U.S. Cl. 99/295; 29/428

(57) ABSTRACT

An adapter for a single-serve beverage machine configured for brewing coffee through a beverage unit, particularly an at least partially plastic unit with integral filter such as a K-cup®, is disclosed. The adapter includes a housing forming an aperture. The housing has upper and lower portions with a screen spanning across the aperture at a transition of the upper and lower portions such that the upper portion and the screen form a well. The housing includes an outer surface adapted to mate with the single-serve beverage machine such that the single-serve beverage machine may be utilized with a coffee-filled paper pod resting in the well instead of the at least partially plastic unit with integral filter. Also disclosed are kits, systems, and methods associated with the adapter, for example a method of adapting a machine from use one type of beverage unit to use with a coffee-filled paper pod.

### BACKGROUND OF THE INVENTION

The present invention relates the adaptation of single-serve beverage machines from utilization of one type of beverage unit, commonly referred to as beverage cartridge, beverage cup, beverage capsule, or beverage pod, to another. Specifically, and using coffee beverage units as an example, the present invention relates to the adaptation of machines that utilize at least partially plastic coffee units with integral filters for use with coffee-filled paper pods.

In recent years an abundance of single-serve beverage machines have been marketed to home and business beverage consumers as a quick and convenient manner of brewing a beverage. Most commonly, such machines brew coffee or tea through at least partially plastic beverage units with integral filters, where the beverage units are filled with coffee grinds or tea leaves. Upon brewing of the coffee or tea, the beverage unit may be quickly and easily discarded, whereby the machine is ready for brewing another beverage with a different beverage unit. In this manner, users may customize their beverages and also enjoy a freshly brewed beverage quickly and easily.

Although convenient, such machines and the associated beverage units have drawbacks.

### BRIEF SUMMARY OF THE INVENTION

Notably, certain of the common commercial beverage units, while plastic and metal, are non-recyclable due to the plastics used and coatings applied to the metals. Thus the beverage units are environmentally unsound.

In addition, such units are typically configured from relatively thin plastics. When hot water for brewing the beverage is passed through the unit the thin plastic quickly reaches a critical temperature that precipitates leaching of harmful chemicals for the beverage consumer.

Also, these units typically suffer from poor yield relative to the volume of product placed within the unit.

Finally, because the units are relatively complex, having for example internal filters and other multiple components, they are more expensive then necessary for brewing a beverage.

It would therefore be advantageous to provide an apparatus that can convert the machines that utilize at least partially plastic coffee units with integral filters for use with environmentally friendly, non-toxic, high yield, and much simpler, coffee-filled paper pods. It would also be advantageous to provide systems and kits of components related to such apparatuses.

To satisfy these needs, the present invention provides, in one embodiment, for an adapter for use in a single-serve beverage machine configured for brewing coffee beverages through an at least partially plastic coffee unit with integral filter, the adapter comprising a housing forming an aperture, the housing having an upper portion and a lower portion, and a screen spanning across the aperture at a transition of the upper portion and the lower portion, such that the upper portion and the screen form a well. The housing includes an outer surface adapted to mate with the single-serve beverage machine such that the single-serve beverage machine may be utilized with a coffee-filled paper pod resting on the screen instead of the at least partially plastic coffee unit with integral filter.

The housing may include a shelf for mating with the single-serve beverage machine, the shelf being positioned at the transition of the upper portion to the lower portion.

The upper portion of the housing may have a first outer diameter and the lower portion of the housing may have a diameter that tapers from a second diameter to a third diameter, the second diameter being less than the first diameter to form a shelf.

The housing may be configured as a single piece. The adapter may further comprise an inner surface with a groove, the screen being fixedly positioned in a friction fit within the groove. The groove may have two sides and may be formed by a curved portion of the housing on one side and a flat portion of the housing on its other side.

The adapter may be formed completely from only the housing and the screen.

The housing may be formed completely from polyoxymethylene.

The at least partially plastic coffee unit with integral filter may be a K-cup®.

The housing may be generally frustoconical.

The housing may have a thickness of at least approximately 1/16″.

In another embodiment, a system for brewing a single-serve beverage may comprise a machine adapted to brew coffee through an at least partially plastic single-serve coffee unit with integral filter, the machine including a single-serve unit holder for holding the single-serve coffee unit with integral filter, and an adapter, the adapter configured to fit at least partially within the single-serve unit holder to adapt the single-serve unit holder for being usable with the at least partially plastic single-serve coffee unit with integral filter to being usable with coffee-filled paper pods.

The system may further comprise a coffee-filled paper pod.

The adapter may be configured from a generally frustoconical outer housing forming an aperture and a screen positioned within the aperture.

The at least partially plastic single-serve coffee unit with integral filter for use within the machine may be a K-cup®.

In a further embodiment, there is disclosed a method of adapting a machine for brewing beverages through K-cups® to brewing beverages through tea or coffee-filled paper pods. The method comprises locating the K-cup® holder within the K-cup® machine, and inserting an adapter at least partially within the K-cup® holder, the adapter comprising a screen configured to support a tea or coffee-filled paper pod.

The method may further comprise locating the upper needle with O-ring of the K-cup® machine, removing the O-ring from the upper needle, and replacing the O-ring with a different O-ring. The different O-ring may be an O-ring formed with a smaller cross-sectional diameter than the O-ring.

In a still further embodiment of the present invention, a kit of component parts for brewing coffee in a K-cup® brewing machine through a coffee-filled paper pod may be provided, the kit comprising a coffee-filled paper pod and an adapter comprising a housing with internal screen, the adapter configured to support the coffee-filled paper pod within a K-cup® holder of a K-cup® brewing machine. The kit may further comprise an O-ring.

### BRIEF DESCRIPTION OF THE DRAWING

The above description, as well as further objects, features and advantages of the present invention will be more fully understood with reference to the following detailed description of the coffee pod adapter and associated systems, methods, and kits, when taken in conjunction with the accompanying drawing, wherein:

FIG. 1 depicts a perspective view of the coffee pod adapter in accordance with one embodiment of the present invention;

FIG. 2 depicts a side view of the coffee pod adapter of FIG. 1;

FIG. 3 depicts a top plan view of the coffee pod adapter of FIG. 1;

FIG. 4 depicts a bottom plan view of the coffee pod adapter of FIG. 1;

FIG. 5 depicts a cross-sectional view of the coffee pod adapter of FIG. 1, in a cross section taken through line A-A of FIG. 1;

FIG. 6 is an exploded view of the coffee pod adapter of FIG. 1 in conjunction with a portion of a beverage machine and a coffee-filled paper pod;

FIG. 7 is an assembled view of the components depicted in FIG. 6; and,

FIG. 8 is a partial schematic view of beverage machine with the coffee pod adapter of FIG. 1 installed.

### DETAILED DESCRIPTION

In describing the preferred embodiments of the subject matter illustrated and to be described with respect to the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

Described herein are embodiments of the coffee pod adapter of the present invention. Also described are systems, methods, and kits related to the adapter.

As discussed above, the coffee pod adapter of the present invention relates to the adaptation of single-serve beverage machines from utilization of one type of beverage unit (also commonly referred to as beverage cartridge, beverage cup, beverage capsule, or beverage pod) to another. In one specific embodiment, the present invention may be utilized to adapt machines configured to use K-cups® to being configured for use with coffee or tea filled paper pods. K-cups®, and K-cup®, which is also used herein, are registered trademarks of Keurig, Incorporated, 55 Walkers Brook Drive, Reading, Mass. 01867.

K-cup® machines use K-cups® for brewing single cups of coffee or tea. As commonly known, the K-cups® are configured from a relatively thin plastic cup with integral filter in a lower portion thereof. The cups are filled above the filter with coffee grinds, ground tea leaves, or the like, and are sealed with a foil cover.

To use a K-cup® for brewing, one typically lifts a component of the K-cup® machine to reveal a single-serve unit holder, or K-cup® holder in this case. A K-cup® is then inserted into the K-cup® holder and a component of the machine is closed over the K-cup® and K-cup® holder. Typically, the component includes a first needle that punctures the upper foil portion of the K-cup® permitting hot water to enter the cup. In turn, the K-cup® holder also includes a second needle that punctures the bottom of the cup allowing the hot water, now impregnated with the beverage and having flowed past the filter, to escape and flow through the remainder of the machine into the consumer's beverage container.

In general, the inventive adapter is designed to fit within a single-serve unit holder of a beverage machine to permit the use of paper pod style single-serve beverage containers in lieu of K-cups® or other beverage units. Although different configurations of the adapter may be utilized for different style machines, or even different configurations within a single style machine, one preferred configuration is shown in the attached figures. This configuration is specifically adapted for use with machines that utilize K-cup® single-serve beverage units, and the remainder of the disclosure will be provided with such a unit as an example. Again, it is to be understood that coffee pod adapters of the present invention may be configured to work with any type of beverage unit.

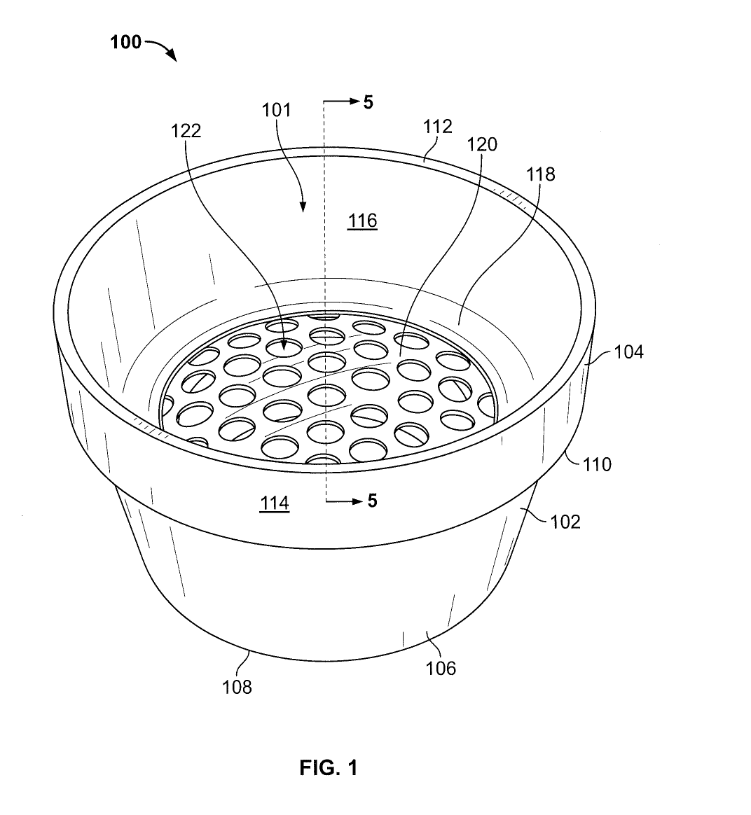

As shown in FIG. 1, in its adaptation for the K-cup® beverage machines, the adapter 100 may be configured as a generally frustoconical housing 102. The housing 102 includes an upper portion 104 and a lower portion 106, where the upper portion has a greater diameter than the lower portion and the lower portion tapers from a first diameter, adjacent the upper portion, to a smaller second diameter, at the base 108 of the adapter. The transition from upper portion 104 to lower portion 106 is abrupt, forming a shelf 110.

The upper surface 112 of the adapter 100 exhibits a thickness from the outer surface 114 of the adapter to the inner surface 116 of the adapter, leaving an aperture 101 open along the longitudinal axis of the adapter. As the inner surface 116 extends from the upper surface 112 to the base 108 of the adapter 100, the inner surface tapers slightly in diameter until tapering more dramatically at a tapered section 118, adjacent the general area of the shelf 110. This tapered section 118 assists with securing a screen 120 having a plurality of apertures 122 and may be considered as a curved area.

As shown in FIG. 1, the screen is preferably crowed toward the upper surface 112, having its central portion above its edges. In conjunction with the upper portion 104 of the housing 102, the screen 120 forms a well. As will be discussed, a coffee-filled paper pod may be placed on the screen 120 in the well.

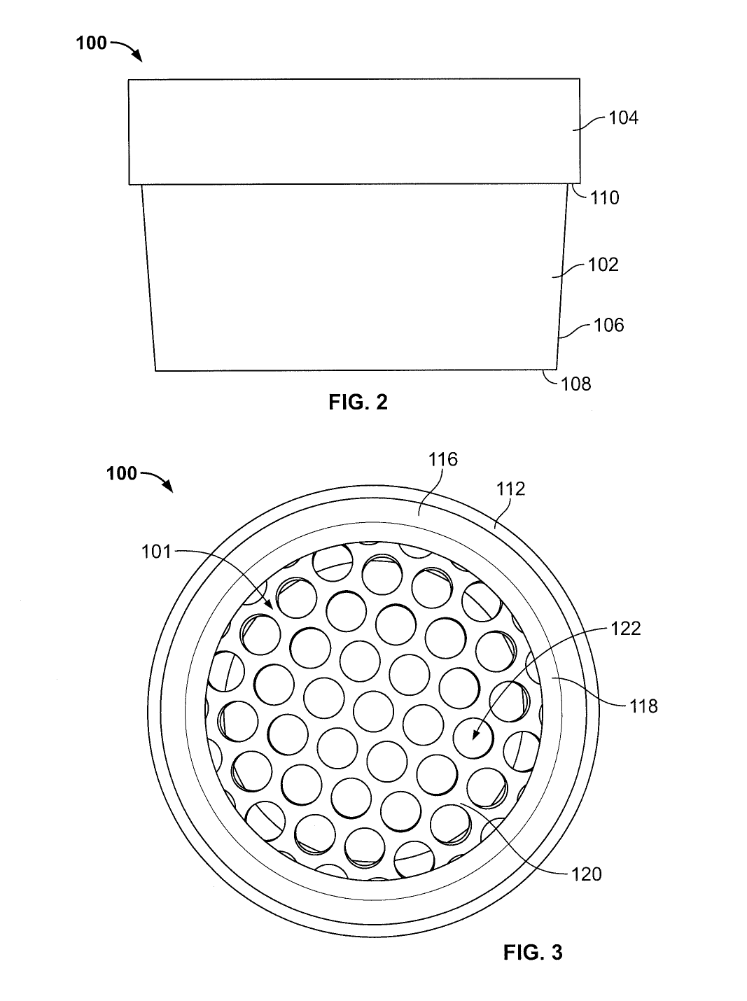

Referring now to FIG. 2, a side view of the adapter 100, one can readily see the transition from the upper portion 104 to the lower portion 106 of the housing 102. Again, this forms a shelf 110. In addition, one can see that the diameter of the upper portion 104 is relatively constant while the diameter of the lower portion 106 tapers from the shelf 110 to the base 108, as it decreases in diameter.

FIG. 3 depicts a top plan view of the adapter 100. As shown in FIG. 3, the interior surface 116 tapers slightly from the upper surface 112 toward the more dramatic tapered section 118, to form the aperture 101. Also shown clearly is the screen 120 with apertures 122 filling the aperture 101. It is noted here that the screen 120, although including a plurality of round apertures 122 in this embodiment, may comprise any number of apertures. In addition, the apertures may be geometric or non-geometric. As will be seen, so long as a coffee-filled paper pod can be supported on the screen 120, and liquid can flow through the apertures 122, the screen configuration can vary.

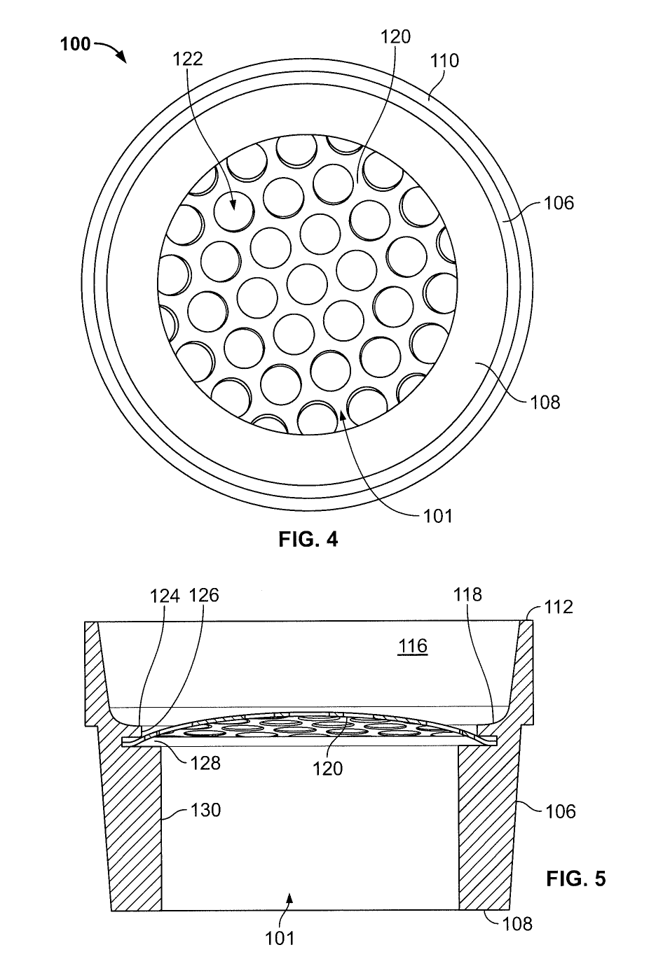

FIG. 4 depicts a bottom plan view of the adapter 100. As shown in FIG. 4, the lower portion 106 tapers from the base 108 toward the shelf 110. Also shown is aperture 101 extending through the adapter 100.

The aperture 101 is shown most clearly in FIG. 5, a cross-sectional view of the adapter 100 taken through line 5-5 of FIG. 1. As shown, the aperture extends fully from the upper surface 112 to the base 108. Also shown in FIG. 5 is the configuration of the inner surface 116 of the adaptor 100. As shown, the inner surface 116 tapers slightly from the upper surface 112 to the tapered section 118. The tapered section 118 in turn ends abruptly within the aperture 101 at a terminus 124. The terminus 124 forms a shoulder 126 above a groove 128 when viewed in conjunction with the inner surface 116 in the area of the lower portion 106 of the housing 102. For ease of reference, this inner surface 116 in the area of the lower portion 106 is depicted with reference 130. The groove 128 completely circumscribes the aperture 101, providing a fitment location for the screen 120.

In order to fit the screen 120 into the groove 128, the screen is initially placed above the aperture 101 in a convex orientation. The screen 120 is then press fit into the aperture 101, starting at the upper surface 112. As the screen 120 descends toward the groove 128, the tapering inner surface 116 influences the screen to reduce in diameter, which in turn increases the severity of the crowning and imparts potential energy into the screen. The screen 120 is finally forced over the terminus 124 of the tapered section 118 of the inner surface 116 and down past the shoulder 126. Once the screen 120 is forced to a position at the level of the groove 128, the screen snaps back toward its original configuration and becomes lodged in the groove in a friction fit. Thus, the screen 120 can be fitted to the housing 102 without resort to glues, adhesives, or other chemicals.

The housing 102 is preferably formed from polyoxymethylene, or acetal resin, such as Dupont™ Delrin®. Delrin® is a registered trademark of E.I. du Pont de Nemours and Company. Other materials may also be utilized, although preference is given to those with high stiffness, excellent dimensional stability, high heat resistance, and extremely low or zero levels of toxicity. Preferably the housing 102 is machined from a single piece of material for stability purposes and to permit the screen 120 to be secured without glues, adhesives, or other chemicals. The screen 120 may in turn be formed from a number of materials, preferably metals, including stainless steel. Preferably, those are the only two components of the entire adapter 100.

For purposes of fitting in a K-cup® machine, the housing 102 has, at the upper portion 104, an outer diameter of approximately 1⅞″. The lower portion 106 tapers from approximately 1⅝″ to approximately 1½″ diameter. The thickness of the upper portion 104, is approximately 1/16″ while the thickness of the lower portion 106 is approximately ¼″. The height of the adapter 100 is approximately 1 1/16″ with the upper portion 104 being approximately ⅜″, leaving the lower portion 106 at approximately 9/16″. Other dimensions, particularly those related to inner portions of the adapter, may be utilized. It is noted, however, that relatively large surface diameters for the screen relative to the depth of the well above the screen are preferred as such a configuration enables a high yield of the extractable solids from the coffee or tea product.

As a point of note regarding the thickness, it is preferred that a minimum thickness of approximately 1/16″ be preserved for the housing 102 as such a thickness prevents the housing material from reaching a critical temperature where toxic chemicals could leach.

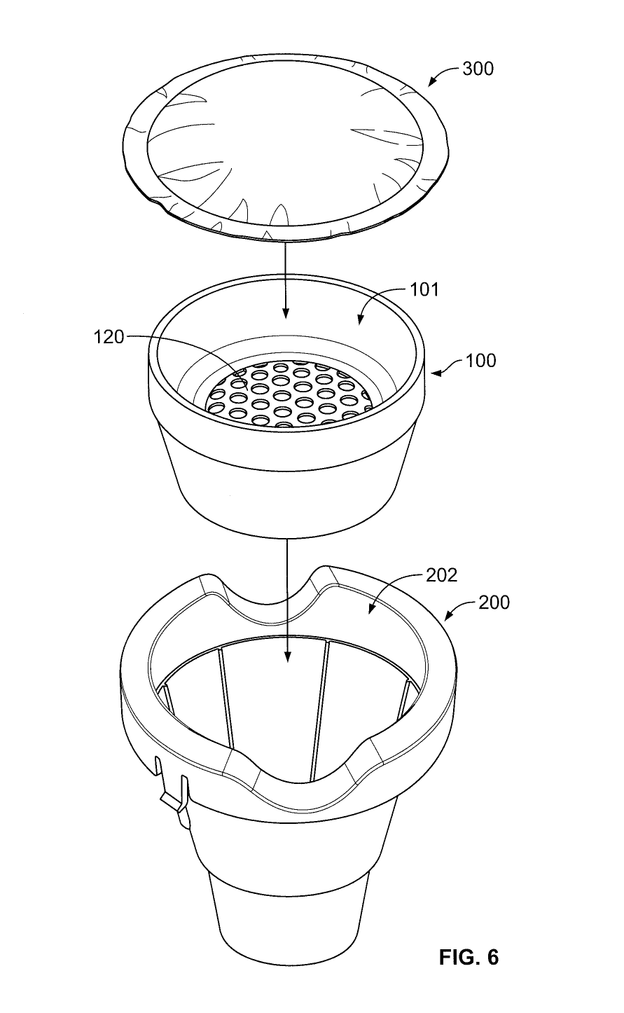

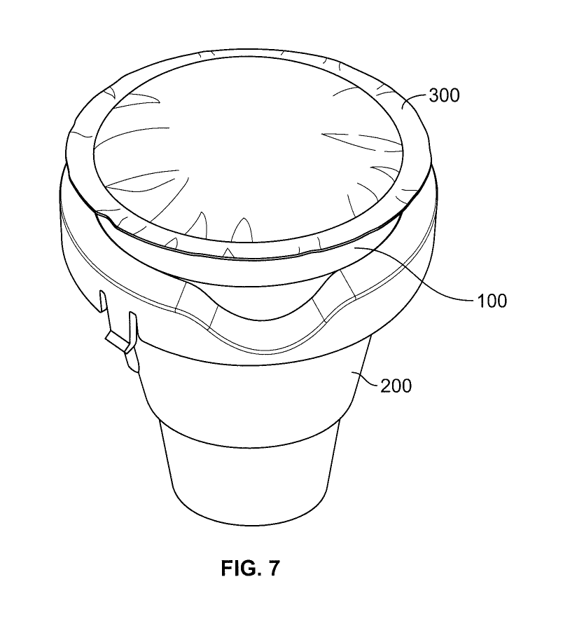

In use, the adaptor 100 may be placed into the well 202 of a single-serve unit holder 200 of a conventional beverage machine, as illustrated in FIG. 6. The adapter 100 is preferably sized and configured to fit squarely within the well 202 of the holder 200 such that liquid flowing through the aperture 101 of the adapter will enter the unit holder 200 without leaking. In turn, a conventional coffee-filled paper pod 300 may be placed on the screen 120 of the adapter 100 within the well of the adapter. The assembled parts are shown in their finished configuration in FIG. 7.

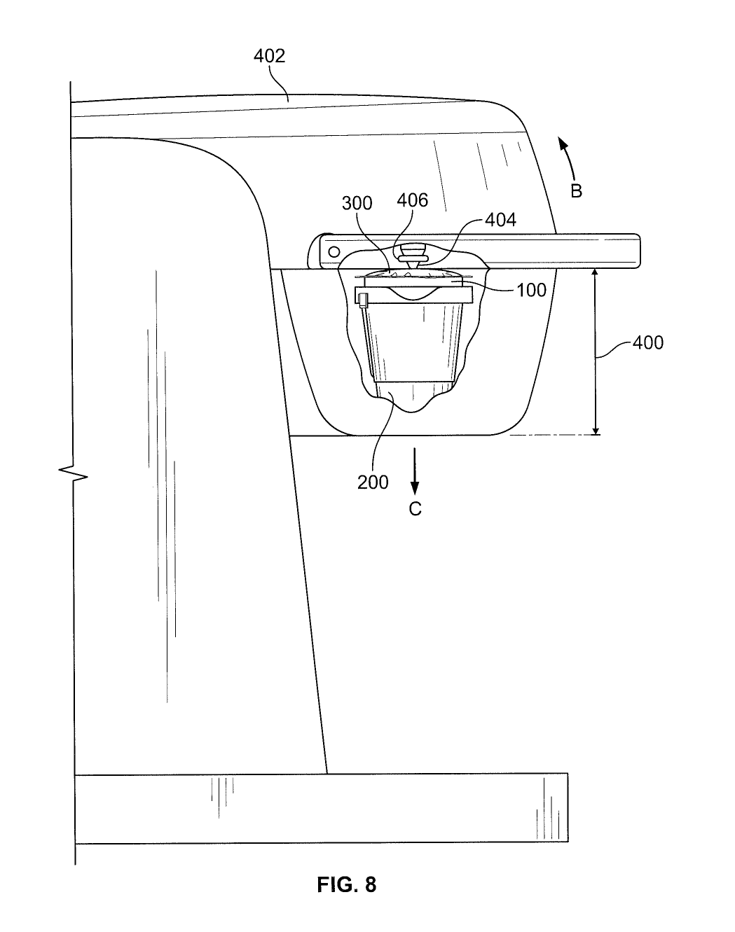

FIG. 8 depicts a partial schematic view of a beverage machine 400 with the coffee pod adapter 100, beverage unit holder 200, and coffee-filled paper pod 300 installed. An operative portion of the beverage machine includes an arm 402 that rotates or moves by translation toward the coffee-filled paper pod 300. Conventionally, the arm 402 includes a needle 404, which may be referred to as an upper needle. Mounted on the needle 404 is an O-ring 406.

For use with conventional beverage units, such as K-cups®, the needle 404 penetrates the upper foil portion as the arm is lowered into position toward the beverage unit along arrow “B.” This permits hot water to be forced through the beverage unit. In the case of the coffee-filled paper pods 300, the needle 404 is not strictly required. However, conventional beverage machines typically have no easy means of removing the needle 404, and therefore it may be left in place. In most cases the needle provides no ill effects. In some cases, it has been found that the needle penetrates the coffee-filled paper pod too far and allows coffee grinds to escape. In accordance with certain methods of the invention, to combat this occurrence the O-ring 406 on the needle 404 may be removed and replaced with a different O-ring, typically smaller in cross-sectional diameter. This helps to more fully seal the needle against the coffee-filled paper pod. Other non-O-ring shaped seals may also be utilized, for example flat washer seals.

Once the arm 400 is lowered and the hot water is permitted to flow through the coffee-filled paper pod 300 and adapter 100, a finished beverage flows out of the unit holder 200 in the direction of arrow “C,” and into the remainder of the machine where it can be delivered to a beverage container (not shown).

In accordance with other embodiments of the invention, it is noted that a kit of component parts may be provided for retrofitting a conventional single-serve beverage machine, preferably a K-cup® machine, for use with coffee-filled paper pods. Such a kit may consist of an adapter 100 and one or more coffee-filled paper pods. The kit may also include an O-ring or other seal.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An adapter for use in a single-serve beverage machine configured for brewing coffee beverages through an at least partially plastic coffee unit with integral filter, the adapter comprising:
a housing forming an aperture, said housing having an upper portion and a lower portion; and
a screen spanning across said aperture at a transition of said upper portion and said lower portion, such that said upper portion and said screen form a well;
wherein said housing includes an outer surface adapted to mate with the single-serve beverage machine such that the single-serve beverage machine may be utilized with a coffee-filled paper pod resting on said screen instead of the at least partially plastic coffee unit with integral filter.

2. The adapter of claim 1, wherein said housing includes a shelf for mating with the single-serve beverage machine, the shelf being positioned at the transition of said upper portion to said lower portion.

3. The adapter of claim 1, wherein said upper portion of said housing has a first outer diameter and said lower portion of said housing has a diameter that tapers from a second diameter to a third diameter, the second diameter being less than the first diameter to form a shelf.

4. The adapter of claim 1, wherein said housing is configured as a single piece.

5. The adapter of claim 4, wherein the adapter further comprises an inner surface with a groove, said screen being fixedly positioned in a friction fit within said groove.

6. The adapter of claim 5, wherein said groove has two sides and is formed by a curved portion of said housing on one side and a flat portion of said housing on its other side.

7. The adapter of claim 1, wherein the adapter is formed completely from only said housing and said screen.

8. The adapter of claim 1, wherein said housing is formed from polyoxymethylene.

9. The adapter of claim 1, wherein the at least partially plastic coffee unit with integral filter is a K-cup®.

10. The adapter of claim 1, wherein said housing is generally frustoconical.

11. The adaptor of claim 1, wherein said housing has a thickness of at least approximately 1/16″.

12. A system for brewing a single-serve beverage, the system comprising:
a machine adapted to brew coffee through an at least partially plastic single-serve coffee unit with integral filter, the machine including a single-serve unit holder for holding the single-serve coffee unit with integral filter; and
an adapter, the adapter configured to fit at least partially within said single-serve unit holder to adapt said single-serve unit holder for being usable with the at least partially plastic single-serve coffee unit with integral filter to being usable with coffee-filled paper pods.

13. The system of claim 12, further comprising a coffee-filled paper pod.

14. The system of claim 12, wherein said adapter is configured from a generally frustoconical outer housing forming an aperture and a screen positioned within said aperture.

15. The system of claim 12, wherein the at least partially plastic single-serve coffee unit with integral filter for use within said machine is a K-cup®.

16. A method of adapting a machine for brewing beverages through K-cups® to brewing beverages through tea or coffee-filled paper pods, the method comprising:
locating the K-cup® holder within the K-cup® machine;
inserting an adapter at least partially within the K-cup® holder, the adapter comprising a screen configured to support a tea or coffee-filled paper pod.

17. The method of claim 16, further comprising:
locating the upper needle with O-ring of the K-cup® machine;
removing the O-ring from the upper needle;
replacing the O-ring with a different O-ring.

18. The method of claim 17, wherein said different O-ring is an O-ring formed with a smaller cross-sectional diameter than said O-ring.
